(19) United States
(12) Patent Application Publication
(10) Pub. No.: US 2023/0143030 A1
(43) Pub. Date: May 11, 2023

(54) BIPOLAR PLATE FOR FUEL CELLS AND THE METHOD OF FORMING THE SAME

(71) Applicant: CHUNG-HSIN ELECTRIC & MACHINERY MFG. CORP., Taoyuan City (TW)

(72) Inventors: Che-Jung HSU, Taoyuan City (TW); Chih-Hung LEE, Taoyuan City (TW)

(21) Appl. No.: 17/719,251

(22) Filed: Apr. 12, 2022

(30) Foreign Application Priority Data
Nov. 9, 2021 (TW) 110141586

(51) Int. Cl. H01M 8/0213; H01M 8/0263

(52) U.S. Cl. CPC H01M 8/0213; H01M 8/0263

(57) ABSTRACT

A bipolar plate for a fuel cell is provided. The bipolar plate is formed by pressing a base plate, wherein the base plate is formed by a soft graphite plate. The soft graphite plate has a density of 0.8-1.3 g/cm³, a carbon content more than 98% and an ash content less than 2%. Based on the thickness of the base plate before pressing, the thickness compression ratio of the bipolar plate is 40-50%.

### CROSS REFERENCE TO RELATED APPLICATIONS

This application claims the benefit of Taiwan Application No. 110141586, filed Nov. 9, 2021, the entirety of which is incorporated by reference herein.

### BACKGROUND

### Technical Field

The present disclosure is related to fuel cells, and more particularly to a bipolar plate of fuel cells.

### Description of the Related Art

Population growth and industrial development have seen an increase in demand for energy. Until now, fossil fuels have been heavily relied upon as the most important source of energy. The use of petroleum has promoted progress in transportation, science and technology, and civilization, but it has also caused air pollution in various places, and triggered the current environmental crisis. Due to the pressures of energy demand and environmental fragility, the development of fuel cells is receiving more and more attention and support from governments around the world.

Proton exchange membrane fuel cell (PEMFC) technology is currently a more mature one among various fuel cells. Proton exchange membrane fuel cells directly and continuously convert the chemical energy of fuel and air into electrical energy. The fundamental principle of PEMFC is to feed fuel (such as hydrogen, methanol, etc.) into the anode side and oxidizer (oxygen, air, etc.) into the cathode side, and make them electrochemically react in the presence of a catalyst to produce water and electricity.

The bipolar plates (anode plates and/or cathode plates) in proton exchange membrane fuel cells are mainly responsible for transporting reaction gases to the catalyst reaction zone for electrochemical reactions, and evenly distributing the reaction gases on the membrane electrode assembly, while conducting the current generated by the chemical reaction. The bipolar plates in fuel cell stacks also perform the function of heat dissipation. During operation of the proton exchange membrane fuels cell, the internal working temperature is between 60 and 80° C., the internal relative humidity is usually 100%, and because of the hydrogen protons produced by electrochemical reactions, the internal environment is acidic (pH=2-3). To summarize, it can be known that the material of the bipolar plate must have high electrical conductivity, good thermal conductivity, and better corrosion resistance. In addition, considering the processing of the flow channel on the bipolar plate, the processing characteristics must be considered when selecting bipolar plate materials.

At present, the most common material used for bipolar plates is graphite, because its material properties meet the above characteristics. However, the drawbacks of graphite are its high material cost, poor mechanical strength, fragility, and limited processing ability. The mechanical properties of graphite make most manufacturers use CNC (Computer Numerical Control) milling machines for processing graphite bipolar plates. The processed graphite bipolar plates have the disadvantages of being thick, bulky, heavy, and so on. The weight of traditional graphite plates accounts for about 50 to 60% of the total weight of a cell stack. It is difficult to use it as bipolar plate material for future miniaturization and lightweight fuel cells. In addition, due to the complicated processing procedure and long processing time of CNC milling machines, it is difficult to reduce the processing cost of using graphite bipolar plates.

Metal materials also have high electrical conductivity and good thermal conductivity, and their excellent ductility allows them to be formed by stamping or hydraulic pressure, so that the thickness of the plate can be effectively reduced. Therefore, the use of metal bipolar plates can further reduce the volume and the weight of the cell stack, in order to increase the power density per unit volume and mass of the cell stack. In addition, the metal bipolar plate has good capacity to resist shocks, which can increase the competitiveness of the fuel cell power system when it is applied in vehicles in the future. In addition to the advantages brought by the better mechanical properties mentioned above, the cost of metal is also lower than that of graphite. The stamping method can also greatly shorten the process time of bipolar plates, thus reducing the cost of batteries in the mass production stage. However, the disadvantage of metal bipolar plates is low corrosion resistance. Under high temperatures, high humidity and the acidic environment of the fuel cell, the metal surface is prone to form a passivation layer due to corrosion and oxidation reactions, which in turn increases contact resistance and reduces the power generation efficiency of the fuel cell. On the other hand, metal ions may also be harmful to the performance of the membrane electrode assembly.

Therefore, the current development technology of bipolar plates still faces many problems. How to provide durable bipolar plates in a low-cost and high-efficiency manner is still an urgent issue in the industry.

### SUMMARY

Some embodiments of the present disclosure provide a bipolar plate for fuel cells, wherein the bipolar plate is formed by pressing a base plate, and the base plate is formed from a soft graphite plate, wherein the soft graphite plate has a density of 0.8-1.3 g/cm3, a carbon content more than 98% and an ash content less than 2%, and based on the thickness of the base plate before pressing, the thickness compression ratio of the bipolar plate is 40-50%.

Some embodiments of the present disclosure provide a fuel cell, comprising: a proton exchange membrane; a pair of catalyst layers arranged respectively on opposite sides of the proton exchange membrane; and a pair of bipolar plates arranged respectively on outer sides of the pair of catalyst layers and sandwiching the proton exchange membrane and the pair of catalyst layers, wherein the pair of bipolar plates are the bipolar plates of other embodiments.

Some embodiments of the present disclosure provide a method of forming a bipolar plate for fuel cells, comprising: a die-cutting step of cutting a soft graphite plate into a base plate; a matching step of placing the base plate in a mold; a pressing step of pressing the mold with the base plate in place; and a demolding step of detaching the pressed base plate from the mold to obtain the bipolar plate, wherein the soft graphite plate has a density of 0.8 to 1.3 g/cm³, a carbon content more than 98% and an ash content less than 2%, and based on the thickness of the base plate before pressing, the thickness compression ratio of the bipolar plate is 40-50%.

### BRIEF DESCRIPTION OF THE DRAWINGS

Aspects of this disclosure are best understood from the following detailed description when read with the accompanying figures. It should be noted that, in accordance with common practice in the industry, various features are not drawn to scale. In fact, the dimensions of the various features may be arbitrarily increased or reduced for clarity of discussion.

FIGS. 1A-1E are partial schematic diagrams showing flow channels of the bipolar plate according to some embodiments.

FIG. 2 is a partial schematic diagram of a fuel cell according to some embodiments.

FIG. 3A is a schematic diagram showing a base plate placed in a mold and pressed according to some embodiments.

FIG. 3B is a schematic diagram showing a bipolar plate obtained after demolding according to some embodiments.

FIGS. 4A-4B are partial side views of the mold according to some embodiments.

### DETAILED DESCRIPTION

The following disclosure provides many different embodiments, or examples, for implementing different features of the subject matter provided. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “overlapped,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure provides a bipolar plate for fuel cells, characterized in that the bipolar plate is formed directly by pressing a soft graphite plate, so as to provide high-durability bipolar plates for fuel cells in a low-cost and high-efficiency manner.

The term “soft graphite plate” used in the present disclosure refers to the graphite plate with a density of 0.8-1.3 g/cm³, a tensile strength of 40-50 kg/cm², a carbon content more than 98% and an ash content less than 2%. According to some embodiments, the soft graphite plate can be made of an expanded graphite material. According to some embodiments, the expanded graphite material may be, for example, made from natural flake graphite through intercalation treatment, water washing, drying, and high temperature expansion. The special structure and characteristics of expanded graphite make it possess the properties of natural graphite as well as other excellent properties, such as: high pressure resistance, flexibility, plasticity and self-lubricating; high resistance to high temperature and low temperature, corrosion resistance, and radiation resistance characteristics; high capacity to resist shocks; high conductivity; high anti-aging, anti-distortion characteristics, etc. According to some embodiments, the soft graphite plate has a density about 0.8-1.3 g/cm³ (for example, 0.9-1 g/cm³, or 0.95-1.2 g/cm³). According to some embodiments, the soft graphite plate has a carbon content more than 98% (for example, more than 98.5%, more than 99%, or more than 99.5%) and an ash content less than 2% (for example, less than 1.5%, less than 1%, or less than 0.5%). In the present disclosure, the high carbon content makes the soft graphite plate achieve high thermal conductivity and electrical conductivity, which meets the requirements of the electrochemical reaction of the fuel cell.

According to some embodiments, the soft graphite plate is die-cut to form a base plate. According to some embodiments, the soft graphite plate does not contain resin, so the bipolar plate formed directly by pressing the base plate after die-cutting can maintain high conductivity. According to some embodiments, the soft graphite plate has a tensile strength of about 40-50 kg/cm² (for example, 42-45 kg/cm², or 43-48 kg/cm²). According to some embodiments, the soft graphite plate has a compression ratio more than 40% (for example, more than 50%, or more than 60%).

According to some embodiments, based on the thickness of the base plate before pressing, the thickness compression ratio of the bipolar plate is 40-50% (for example, 42-45%, or 43-48%), that is, based on the thickness of the base plate before pressing, the thickness of the bipolar plate formed after pressing is reduced by 40-50%. In the above, the thickness of the base plate refers to the maximum thickness of the entire base plate, and the thickness of the bipolar plate refers to the maximum thickness of the entire bipolar plate. According to some embodiments, based on the thickness of the base plate before pressing, the thickness deformation of the bipolar plate is 0.5-1 mm (for example, 0.6-0.9 mm, or 0.7-0.8 mm). In general, the soft graphite plate needs to be impregnated with the resin to obtain higher mechanical strength. However, in the present disclosure, by controlling the thickness compression ratio and/or the thickness deformation of the bipolar plate, the bipolar plate formed from the soft graphite can be made sufficiently rigid without cracking. If the thickness compression ratio of the bipolar plate is too low, the strength of the bipolar plate will be too low and the impedance value will be too high. If the thickness compression ratio of the bipolar plate is too high, the bipolar plate will be more difficult to demold and will crack easily during the pressing process. According to some embodiments, the density of bipolar plates is about 1 to 3 g/cm³ (for example, 1.2 to 2.5 g/cm³, or 1.6 to 2 g/cm³).

According to some embodiments, the soft graphite plate has a sulfur content less than 1000 ppm and a chloride content less than 50 ppm. By controlling the sulfur content and chloride content in the soft graphite plate, the impact on the catalyst in the fuel cell can be suppressed, thereby improving the durability of the fuel cell.

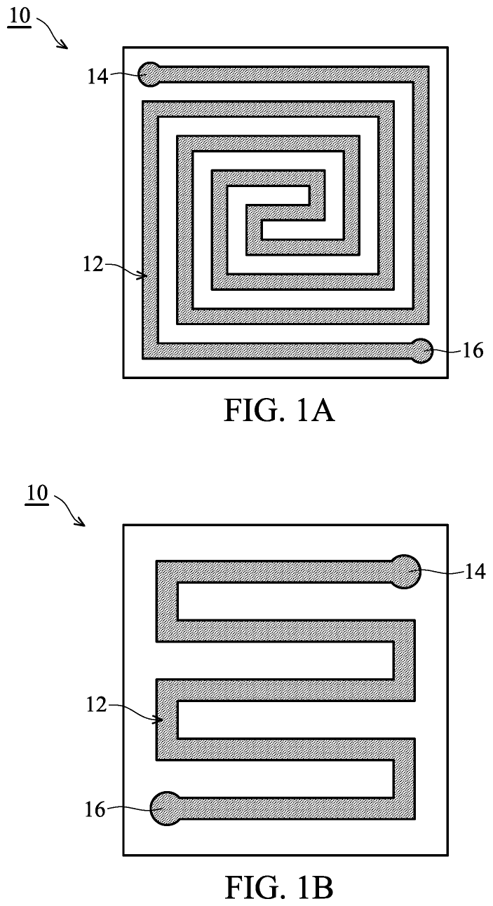

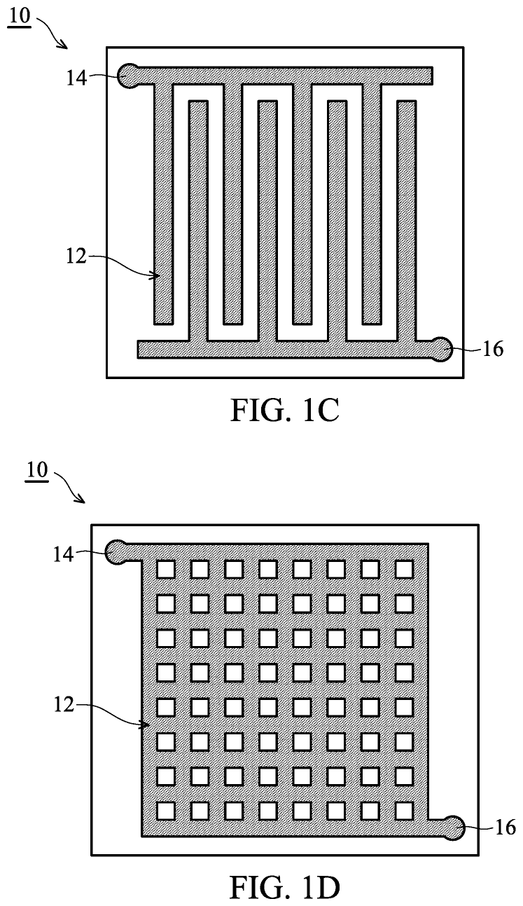

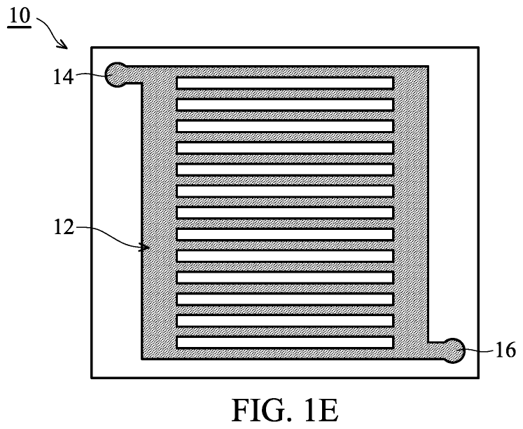

Bipolar plates with different flow channels can be obtained according to different mold designs. Referring to FIGS. 1A to 1E, according to some embodiments, the bipolar plate 10 has a flow channel 12, a flow channel inlet 14, a flow channel outlet 16, etc. The flow channel 12 can be, for example, a spiral channel (as shown in FIG. 1A), a serpentine channel (as shown in FIG. 1B), an interdigitated channel (as shown in FIG. 1C), a pin-type channel (as shown in FIG. 1D), or a parallel channel (as shown in FIG. 1E), etc. According to some embodiments, the depth of the flow channel of the bipolar plate 10 is about less than 1 mm (for example, less than 0.8 mm, or less than 0.5 mm).

According to some embodiments, the bipolar plate of the present disclosure may be used as a bipolar plate for fuel cells (anode plate and/or cathode plate). According to some embodiments, the flow channel of the present bipolar plate can be used as gas (e.g. hydrogen, air, etc.) flow channel and/or liquid (e.g. cooling fluid, methanol, etc.) flow channel According to some embodiments, the bipolar plate may have flow channel on both sides. According to some embodiments, the bipolar plate may have flow channel on a single side.

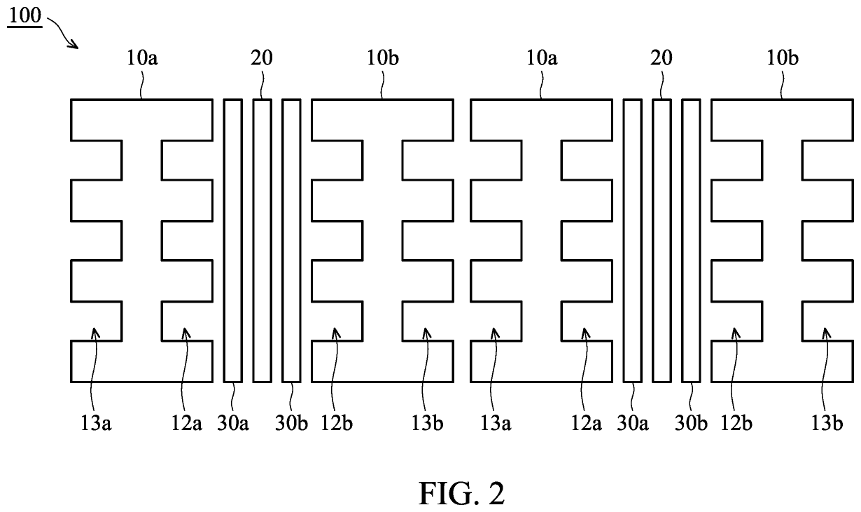

Referring to FIG. 2, according to some embodiments, FIG. 2 is a partial schematic view of a fuel cell 100 using a bipolar plate of the present disclosure. According to some embodiments, the fuel cell 100 may be a plurality of single cells connected in series. According to some embodiments, the fuel cell 100 includes a proton exchange membrane 20. According to some embodiments, the fuel cell 100 includes a pair of catalytic layers (anodic catalytic layer 30a and cathodic catalytic layer 30b) arranged respectively on each side of the proton exchange membrane 20. According to some embodiments, the fuel cell 100 includes a pair of bipolar plates (anode plate 10a and cathode plate 10b) arranged respectively on the outer side of the anode catalyst layer 30a and the cathode catalyst layer 30b and sandwiching the proton exchange membrane 20, the anode catalyst layer 30a and the cathode catalyst layer 30b. According to some embodiments, the hydrogen enters the flow channel 12a from the inlet of the anode plate 10a and diffuses to the anode catalyst layer 30a through the gas diffusion layer (not shown). The proton is “attracted” to the other side of the proton exchange membrane 20, while the electron forms a current via an external circuit and reaches the cathode. In the presence of the cathode catalyst layer 30b, the hydrogen protons, oxygen and electrons react to form water molecules. According to some embodiments, the anode catalyst layer 30a may include, for example, Pt, Ru, Ni, etc. According to some embodiments, the cathode catalyst layer 30b may include, for example, Pt, Ni, etc. According to some embodiments, the anode plate 10a and the cathode plate 10b of the fuel cell 100 may also have a flow channel 13a and a flow channel 13b, respectively. According to some embodiments, the flow channel 13a and the flow channel 13b are flow channels for the cooling fluid. Although fuel cells have better transfer efficiency than conventional internal combustion engines, about 50% of the energy is still dissipated in the form of waste heat. Therefore, the flow channels 13a and 13b allow the cooling fluid to be distributed evenly over the surfaces of the anode plate 10a and cathode plate 10b, and achieve the effect of uniform heat dissipation. It should be appreciated that the fuel cell 100 may also include other commonly known components such as collector plates, end plates, sealing layers, etc., which are not described in detail here for simplicity.

In the following, the method of manufacturing bipolar plates is further described.

According to some embodiments, the manufacture of the bipolar plate includes a die-cutting step of cutting a soft graphite plate into a base plate. The commercially available soft graphite plates can be used directly as the soft graphite plate for the die-cutting step. According to some embodiments, the size of the soft graphite plate before die-cutting may be, for example, about 20 to 40 cm in length (for example, about 23 to 35 cm, or 25 to 30 cm), about 20 to 40 cm in width (for example, about 23 to 35 cm, or 25 cm to 30 cm), and about 0.3 to 3 cm in height (for example, about 1 to 2.8 cm, or 1.5 to 2.5 cm). The size of the base plate after die-cutting can be determined according to requirements, and can be, for example, about 3 to 30 cm in length (for example, about 10 to 28 cm, or 15 to 20 cm), about 3 to 30 cm in width (for example, about 10 to 28 cm, or 15 to 20 cm), and about 0.3 to 3 cm in height (for example, about 1 to 2.8 cm, or 1.5 to 2.5 cm). In addition, the flow channel outlet and the flow channel inlet (gas outlet, inlet and/or coolant outlet and inlet) can be cut in the die-cutting step, and the position and size of the cut outlet and inlet of the flow channel can be determined according to actual product requirements.

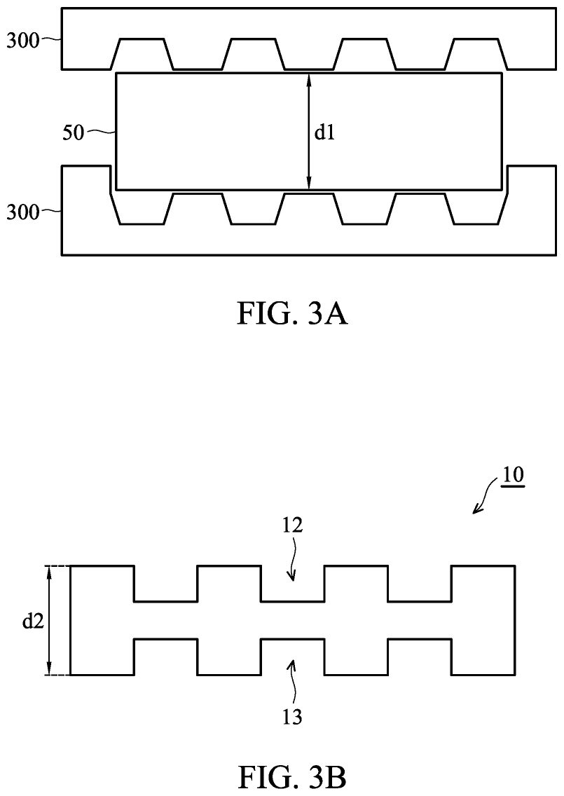

According to some embodiments, a matching step is carried out after the die cutting step. As shown in FIG. 3A, the base plate 50 is placed in the mold 300, wherein the thickness of the base plate 50 is d1. According to some embodiments, a suitable mold 300 can be manufactured and selected according to the requirements, and the shape of the flow channel of the bipolar plate formed after pressing can be determined by setting the pattern on the mold 300, and the size of the bipolar plate can be determined by the outer frame of the mold.

According to some embodiments, the matching step is followed by a pressing step of pressing the mold 300 with the base plate 50 in place. Through the application of pressure, the base plate 50 is deformed according to the pattern of the mold 300, thereby forming a shape with a specific flow channel According to some embodiments, the pressure of the pressing step is approximately 300 to 1500 kg/cm² (e.g. 500 to 1300 kg/cm², 650 to 1200 kg/cm², or 700 to 1000 kg/cm²). By controlling the pressure within this range, the thickness compression ratio and/or the thickness deformation of the bipolar plate can be controlled so that the bipolar plate has sufficiently rigidity. According to some embodiments, the pressing step is performed at room temperature for about 0.05 to 3 min (e.g. 1 to 2.5 min, or 1.5 to 2.3 min).

According to some embodiments, a demolding step is performed after the pressing step. The pressed base plate 50 is detached from the mold 300 by hitting the demolding base downward, and the bipolar plate 10 with the flow channel 12 and the flow channel 13 is obtained, as shown in FIG. 3B, wherein the maximum thickness of the entire bipolar plate 10 is d2. According to some embodiments, based on the thickness d1 of the base plate 50 before pressing, the thickness compression ratio of the bipolar plate 10 is 40-50%, that is, (d2/d1)×100%=40-50%. According to some embodiments, the entire manufacturing process does not exceed 5 min (for example, 1 to 4 min, or 2 to 3 min), which greatly shortens the processing time of the bipolar plate.

According to some embodiments, the pressing pressure and the thickness deformation of the bipolar plate have a relationship as listed in Table 1. Wherein the length of the base plate used in the embodiment is about 5 to 25 cm, the width is about 5 to 25 cm, the height is about 0.5 to 2 cm, and the pressing duration is 1 to 2 min.

TABLE 1

| | | Thickness |
|---|---|---|
| Total output power of | Pressing pressure | deformation |
| hydraulic cylinder (kgf) | (kg/cm²) | (mm) |
| 0 | 0 | 0 |
| 5,000 | 312.5 | 0.803 |
| 10,000 | 625 | 0.919 |
| 15,000 | 937.5 | 0.946 |
| 20,000 | 1,250 | 0.989 |

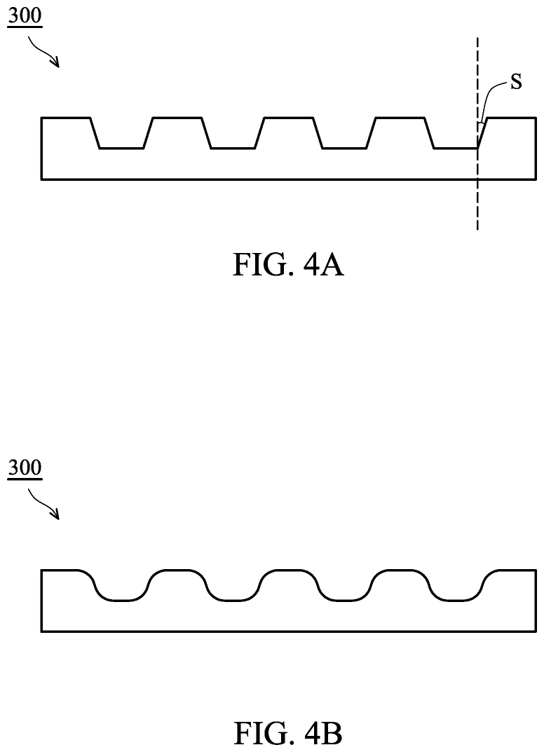

According to some embodiments, the mold has a draft angle of 1 to 10°. According to some embodiments, the mold is further designed with a guide/rounding angle. The draft angle, also known as the release slope, is a slope on both sides of the mold chamber designed to facilitate demolding. In order to allow the molded products to be removed smoothly from the mold, the draft angle must be set on the wall along the direction of the mold opening and closing to facilitate demolding. Because the soft graphite plate tends to adhere to the mold, by setting the draft angle of the mold in the range of 1 to 10°, the friction during demolding is reduced and the bipolar plates can be released completely. Conventional molds with a right-angle design do not have draft angles and are more difficult to demold later. Refer to FIGS. 4A-B below. According to some embodiments, FIG. 4A shows a partial side view of the mold 300. The angle between the side wall of the mold 300 and its vertical direction is the draft angle s. The mold 300 having the draft angle s reduces the friction between the mold and the pressed material in the vertical direction during demolding and therefore makes demolding of the pressed material easier. According to some embodiments, the draft angle s may be from about 1 to about 10° (e.g. from about 2 to about 8°, or from about 3 to about 6°). According to some embodiments, the mold 300 has a guide/rounding angle in addition to the draft angle, as shown in FIG. 4B, further reducing friction.

According to some embodiments, after demolding, various physical inspections can be conducted to confirm that the specifications of the bipolar plate meet the requirements of the product. For example, a thickness gauge can be used to detect the thickness of the bipolar plate; a depth gauge can be used to detect the depth of the flow channel of the bipolar plate; and a caliper can be used to detect the length of the bipolar plate. According to some embodiments, the bipolar plate can be attached for air leakage detection. According to some embodiments, a resistance test and an electrical test can be performed on the bipolar plate.

Because of the fragility of the graphite material, the bipolar plate made of graphite is generally difficult to process, and the processing time is long. A piece of pure graphite bipolar plate requires several hours of processing time. In contrast, the soft graphite plate of the present disclosure has high plasticity, and the processing of the bipolar plate can be completed only by pressing for a short time at room temperature (for example, less than 5 min), which greatly reduces the processing time and processing cost of the bipolar plate, saving at least 90% of the processing time and 90.2% of the processing cost. Also, due to the flexibility of the soft graphite plate, it has better capacity to resist shocks than graphite materials, and is more suitable for vehicles such as electric cars. In addition, the price of graphite is relatively high. A piece of pure graphite bipolar plate costs hundreds of dollars only in material cost, while the material cost of a bipolar plate made of soft graphite plate is only a few dollars, saving at least 90% of the material cost. Besides, the bipolar plate made of soft graphite plate can be tested for airtightness and electrical properties to prove that the material does not affect the fuel cell performance. That is, the bipolar plate formed by pressing the soft graphite plates in the present disclosure can save the processing cost and shorten the processing time without reducing the performance of the fuel cell.

In the prior art, although metal bipolar plates can be processed quickly through the stamping process and the cost of metal is lower than graphite, but the metal bipolar plates are prone to oxidation in the high temperature, high humidity and acidic environment of the fuel cell, which requires additional application (plating) of anti-oxidation surface treatment, so its durability is low. In comparison, the soft graphite plate of the present disclosure will not have oxidation problems, and is more suitable for long-term products.

In summary, the bipolar plate made of soft graphite plate in the present disclosure has the advantages of low cost, fast processing, and good durability.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Although the subject matter has been described in terms specific to structural features or method actions, it should be understood that the subject matter of the claimed scope need not be limited to the specific features or actions described above. Rather, the particular features and actions described above are disclosed as examples of forms that achieve at least some of the claimed scope.

What is claimed is:

1. A bipolar plate for fuel cells, wherein the bipolar plate is formed by pressing a base plate, and the base plate is formed from a soft graphite plate, wherein the soft graphite plate has a density of 0.8-1.3 g/cm³, a carbon content more than 98% and an ash content less than 2%, and based on a thickness of the base plate before pressing, a thickness compression ratio of the bipolar plate is 40-50%.

2. The bipolar plate as claimed in claim 1, wherein based on the thickness of the base plate before pressing, a thickness deformation of the bipolar plate is 0.5-1 mm.

3. The bipolar plate as claimed in claim 1, wherein the soft graphite plate has a sulfur content less than 1000 ppm and a chlorine content less than 50 ppm.

4. The bipolar plate as claimed in claim 1, wherein the bipolar plate has a density of 1-3 g/cm³.

5. The bipolar plate as claimed in claim 1, wherein a flow channel of the bipolar plate has a depth less than 1 mm.

6. The bipolar plate as claimed in claim 1, wherein a flow channel of the bipolar plate is a spiral channel, a serpentine channel, an interdigitated channel, a pin-type channel, or a parallel channel.

7. A fuel cell, comprising:
a proton exchange membrane;
a pair of catalyst layers arranged on opposite sides of the proton exchange membrane; and
a pair of bipolar plates arranged on outer sides of the pair of catalyst layers and sandwiching the proton exchange membrane and the pair of catalyst layers, wherein the pair of bipolar plates are the bipolar plates of claim 1.

8. A method of forming a bipolar plate for fuel cells, comprising:
a die-cutting step of cutting a soft graphite plate into a base plate;
a matching step of placing the base plate in a mold;
a pressing step of pressing the mold with the base plate in place; and
a demolding step of detaching the pressed base plate from the mold to obtain the bipolar plate, wherein the soft graphite plate has a density of 0.8-1.3 g/cm³, a carbon content more than 98% and an ash content less than 2%, and based on a thickness of the base plate before pressing, a thickness compression ratio of the bipolar plate is 40-50%.

9. The method as claimed in claim 8, wherein the mold has a draft angle of 1-10°.

10. The method as claimed in claim 8, wherein the pressing step is performed at a pressure of 300-1500 kg/cm².

11. The method as claimed in claim 8, wherein the pressing step is performed at room temperature.

12. The method as claimed in claim 11, wherein the pressing step is performed for 0.05-3 min.
